(19) United States
(12) Patent Application Publication
(10) Pub. No.: US 2025/0288906 A1
(43) Pub. Date: Sep. 18, 2025

(54) DISPLAY DEVICE AND CONTROL METHOD THEREOF

(71) Applicant: SAMSUNG ELECTRONICS CO., LTD., Suwon-si Gyeonggi-do (KR)

(72) Inventor: Kwangsun BAEK, Suwon-si (KR)

(73) Assignee: SAMSUNG ELECTRONICS CO., LTD., Suwon-si Gyeonggi-do (KR)

(21) Appl. No.: 19/222,207

(22) Filed: May 29, 2025

Related U.S. Application Data
(63) Continuation of application No. PCT/KR2023/016888, filed on Oct. 27, 2023.

(30) Foreign Application Priority Data
Dec. 5, 2022 (KR) 10-2022-0167618

(51) Int. Cl. A63F 13/52; H04N 19/112; H04N 19/156; H04N 19/172; H04N 19/176

(52) U.S. Cl. CPC A63F 13/52; H04N 19/112; H04N 19/156; H04N 19/172; H04N 19/176

(57) ABSTRACT

A display device is disclosed. The display device may comprise a communication interface, a display, a memory, and one or more processors which, when encoded content is streamed from an external server via the communication interface, decode the encoded content using a decoder, store the decoded content in the memory, read the decoded content from the memory on the basis of an output sync signal of the display, and output the decoded content through the display. The one or more processors may adjust the output timing of the output sync signal on the basis of decoding status information from the decoder.

### CROSS-REFERENCE TO RELATED APPLICATIONS

This application is a continuation of International Application No. PCT/KR2023/016888, filed Oct. 27, 2023, and claims foreign priority to Korean Application No. 10-2022-0167618, filed Dec. 5, 2022, which are incorporated herein by reference in their entireties.

### TECHNICAL FIELD

The disclosure relates to a display device and a control method thereof, and more particularly, to a display device that receives a streaming content, a server device that streams a content, and a control method thereof.

### BACKGROUND ART

Broadcasting and OTT, cloud gaming, and mirroring services, etc. are services in a form of transmitting a compressed image stream from a system performing a role of a server to a client system, and displaying the image stream to a user. A client may receive input of data and requests from a user and transmit them to a server, and the server may provide a service to fit the transmitted user data.

For example, in the case of a cloud gaming service, a game service that is not greatly limited by CPU/graphic card performances on the client side is possible, and a multi-platform service in various terminals such as a TV, a smartphone, etc. other than a PC is possible. Instead, technologies for improvement of the Internet speed and the network quality, improvement of the processing speed of a server, minimization of the delay time, etc. are needed.

### DISCLOSURE

### Technical Solution

A display device according to an embodiment includes a communication interface, a display, memory, and at least one processor configured to, based on an encoded content being streamed from an external server through the communication interface, decode the encoded content by using a decoder, and store the decoded content in the memory, adjust an output timing of an output sync signal of the display based on decoding status information of the decoder, read the decoded content from the memory based on the adjusted output sync signal and output the content through the display.

According to an embodiment, the decoder may decode frames included in the encoded content in units of decoding blocks. The at least one processor may, based on receiving the decoding status information including position information of a decoding block corresponding to a first frame that is currently decoded from the decoder, delay the output sync signal of the display on the basis of the position information of the current decoding block, and read the first frame for which decoding was completed from the memory and output the first frame by synchronizing the first frame to the delayed output sync signal.

According to an embodiment, the at least one processor may, based on identifying that decoding of the first frame will be completed within a threshold time based on the position information of the current decoding block, delay the output sync signal of the display based on a time point of completion of the decoding of the first frame, and read the first frame for which decoding was completed from the memory and output the first frame by synchronizing the first frame to the delayed output sync signal.

According to an embodiment, the at least one processor may read a second frame that was decoded before the first frame from the memory and output the second frame by synchronizing the second frame to the output timing of a first Vsync signal, and based on identifying that decoding of the first frame will be completed within a threshold time based on the position information of the current decoding block, delay the output timing of a second Vsync signal after the first Vsync signal until the time point of completion of decoding and output the signal, and read the decoded first frame from the memory and output the first frame by synchronizing the first frame to the output timing of the first Vsync signal.

According to an embodiment, the at least one processor may, based on an output frequency of the display being n times of an image frequency of the encoded content, output the second frame that was decoded before the first frame repeatedly by n times, and then delay the output sync signal of the display based on the position information of the current decoding block, and read the first frame for which decoding was completed from the memory and output the first frame by synchronizing the first frame to the delayed output sync signal.

According to an embodiment, the at least one processor may, based on the output frequency of the display being n times of the image frequency of the encoded content, read the decoded first frame from the memory repeatedly by n times, and output the first frame by synchronizing the first frame to the delayed output sync signal.

According to an embodiment, the at least one processor may read the decoded content from the memory by applying at least one of a rotation, a vertical (V) flip, or a horizontal (H) flip based on at least one of an output mode of the display or a scan mode of the display, and output the content through the display, and the output mode may include a horizontal output mode or a vertical output mode.

According to an embodiment, the at least one processor may, based on a resolution of the encoded content streamed from the external server varying according to a network status, omit an image quality processing operation that is additionally applied to a relatively low resolution such that output latency is maintained.

According to an embodiment, the at least one processor may, based on a bitrate of the encoded content streamed from the external server being reduced according to a network status, omit an artificial intelligence (AI) image quality processing operation that is additionally applied to a relatively low bitrate such that output latency is maintained.

According to an embodiment, the external server may provide a cloud gaming service. The at least one processor may, based on receiving a user control instruction for a game screen output through the display, transmit the user control instruction to the external server through the communication interface, and based on an encoded content to which the user control instruction was reflected being streamed from the external server, decode the encoded content and store the content in the memory, and read the decoded content from the memory and output the content through the display.

A control method of a display device according to an embodiment includes the steps of, based on an encoded content being streamed from an external server, decoding the encoded content by using a decoder, and storing the decoded content in memory, adjusting an output timing of an output sync signal of a display based on decoding status information of the decoder, and reading the decoded content based on the adjusted output timing and outputting the content through the display.

According to an embodiment, the decoder may decode frames included in the encoded content in units of decoding blocks, and in the step of adjusting the output timing of the output sync signal, based on receiving the decoding status information including position information of a decoding block corresponding to a first frame that is currently decoded from the decoder, the output sync signal of the display may be delayed on the basis of the position information of the current decoding block, and in the step of outputting through the display, the first frame for which decoding was completed may be read from the memory and output by synchronizing the first frame to the delayed output sync signal.

According to an embodiment, in the step of adjusting the output timing of the output sync signal, based on identifying that decoding of the first frame will be completed within a threshold time on the basis of the position information of the current decoding block, the output sync signal of the display may be delayed based on a time point of completion of the decoding of the first frame.

According to an embodiment, the control method may further include the step of reading a second frame that was decoded before the first frame from the memory and outputting the second frame by synchronizing the second frame to the output timing of a first Vsync signal. In the step of adjusting the output timing of the output sync signal, based on identifying that decoding of the first frame will be completed within a threshold time on the basis of the position information of the current decoding block, the output timing of a second Vsync signal after the first Vsync signal may be delayed until the time point of completion of decoding and the signal may be output, and in the step of outputting through the display, the decoded first frame may be read from the memory and output by synchronizing the first frame to the output timing of the first Vsync signal.

According to an embodiment, the control method may further include the steps of, based on an output frequency of the display being n times of an image frequency of the encoded content, outputting the second frame that was decoded before the first frame repeatedly by n times, and then delaying the output sync signal of the display based on the position information of the current decoding block, and reading the decoded first frame from the memory and outputting the first frame by synchronizing the first frame to the delayed output sync signal.

According to an embodiment, in the step of outputting by synchronizing to the delayed output sync signal, based on the output frequency of the display being n times of the image frequency of the encoded content, the decoded first frame may be read from the memory repeatedly by n times, and the first frame may be output by synchronizing the first frame to the delayed output sync signal.

According to an embodiment, the control method may further include the step of reading the decoded content from the memory by applying at least one of a rotation, a vertical (V) flip, or a horizontal (H) flip based on at least one of an output mode of the display or a scan mode of the display, and outputting the content through the display, and the output mode may include a horizontal output mode or a vertical output mode.

In a non-transitory computer-readable medium storing computer instructions which, when executed by a processor of a display device, cause the display device perform operations according to an embodiment, the operations may include the steps of, based on an encoded content being streamed from an external server, decoding the encoded content by using a decoder, and storing the decoded content in memory, adjusting an output timing of an output sync signal of a display based on decoding status information of the decoder, and reading the decoded content based on the adjusted output timing and outputting the content through the display.

### DESCRIPTION OF DRAWINGS

FIG. 1A and FIG. 1B are diagrams for schematically illustrating a content streaming system according to an embodiment of the disclosure;

FIG. 2A is a block diagram illustrating a configuration of a display device according to an embodiment;

FIG. 2B is a block diagram illustrating in detail a configuration of a display device according to an embodiment;

FIG. 2C is a diagram for illustrating a method of processing a content of a display device according to an embodiment;

FIG. 3 is a diagram for illustrating a control method of a display device according to an embodiment;

FIG. 4, FIG. 5A, FIG. 5B, FIG. 6A, and FIG. 6B are diagrams for illustrating a control method of a display device according to an embodiment;

FIG. 7, FIG. 8A, and FIG. 8B are diagrams for illustrating a control method of a display device according to an embodiment;

FIG. 9, FIG. 10A, FIG. 10B, and FIG. 10C are diagrams for illustrating a control method of a display device according to an embodiment; and

FIG. 11 is a diagram for illustrating an implementation example of a method of providing a content according to an embodiment.

### MODE FOR INVENTION

First, terms used in this specification will be described briefly, and then the disclosure will be described in detail.

As terms used in the embodiments of the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

In addition, in this specification, terms such as “have,” “may have,” “include” and “may include” should be construed as denoting that there are such characteristics (e.g.: elements such as numerical values, functions, operations, and components), and the terms are not intended to exclude the existence of additional characteristics.

Further, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

Also, the expressions “first,” “second,” and the like used in this specification may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Also, singular expressions include plural expressions, unless defined obviously differently in the context. Further, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the embodiments of the disclosure, “a module” or “a part” performs at least one function or operation, and may be implemented as hardware or software, or as a combination of hardware and software. Also, a plurality of “modules” or “parts” may be integrated into at least one module and implemented as at least one processor (not shown), except “a module” or “a part” that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, an embodiment of the disclosure will be explained in more detail with reference to the accompanying drawings.

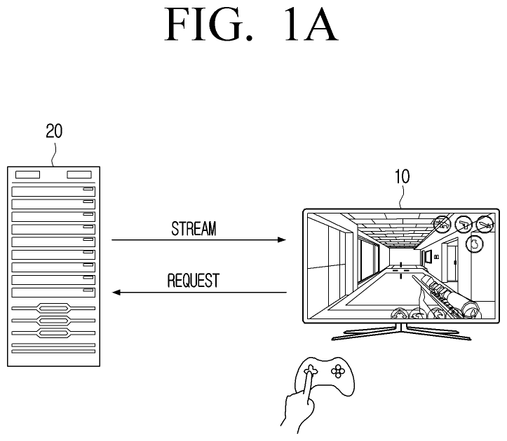

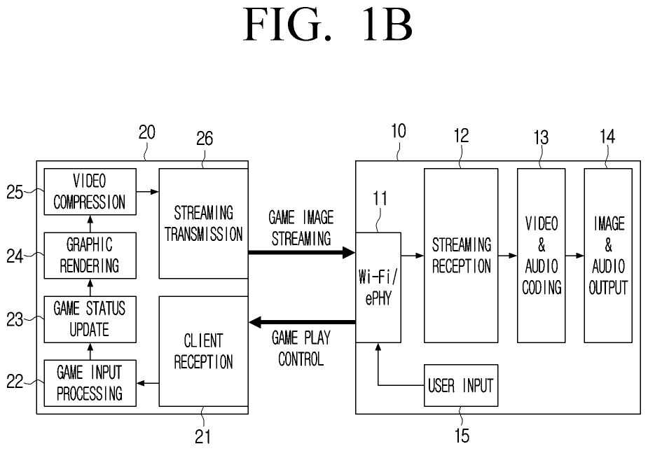

FIG. 1A and FIG. 1B are diagrams for schematically illustrating a content streaming system according to an embodiment of the disclosure.

According to the embodiment illustrated in FIG. 1A, a content streaming system may include a client device 10 and a server device 20.

For streaming an image of a high image quality/a high resolution such as 4K, 8K, etc. through a network, an image encoding technology that can reduce a required bandwidth of a network is important. For an image encoding technology and up/down scaling, standard codecs such as H.264/265, VP8/9, and AV1 are being widely used, and in the case of OTT companies, they are servicing a 4K image by compressing the image to about 15 Mbps based on H.265. To provide a service to fit different network environments of each user, images should be compressed in image resolutions and transmission rates in various combinations, and a technology used for this is an up/down scaling technology. For example, when an 8K image is to be transmitted at a level of about 15 Mbps, the server device 20 may downscale the image and encode the downscaled image, and transmit the image to the client device 10. The client device 10 may decode the image received from the server device 20, and display the decoded image. Also, the client device 10 may upscale and display the decoded image when necessary.

In the case of a real time image streaming service according to an embodiment, the server device 20 may downscale and encode an image in real time based on a resolution and/or a compression bitrate selected in real time. For example, the real time image streaming service may include a cloud gaming service, a live broadcasting service, a mirroring service, a video communication service, etc.

In the case of providing a cloud gaming service according to an embodiment, as illustrated in FIG. 1A, the server device 20 may stream a game image and audio to the client device 10. For example, as illustrated in FIG. 1B, when a game image is received through streaming 12 through a communication function 11, the client device 10 may video/audio decode 130 the received game image and audio, and output 13 them through a display and a speaker. When a user input is received, the client device 100 may transmit a game play control signal corresponding to the received user input to the server device 20.

The server device 20 may process 22 a game input based on the game play control signal received from the client device 20 through a client reception function 21, and update 23 the game status based on the processed game input. Also, the server device 20 may perform graphic rending 24 of the game image based on the updated game status, and video compress 25 and audio compress the rendered image. Further, the server device 20 may transmit the video compressed image and the audio compressed audio to the client device 10 through a streaming transmission function 26.

Meanwhile, as a stream received at the client device 20 goes through various data paths until it is output on the final screen, there is a problem that the game response speed becomes slower. For example, the client device 20 goes through a process of decoding and storing a received stream, and reading/writing the stream for post-processing (e.g., scaling), and thus time until the stream is output on the final screen may be delayed.

Accordingly, hereinafter, various embodiments of providing an optimal cloud game environment by minimizing the time until a stream received at the client device 20 is output on the final stream will be explained.

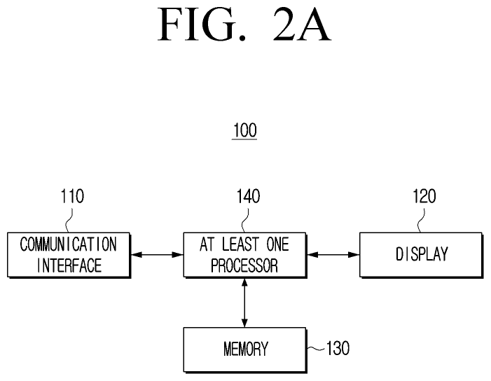

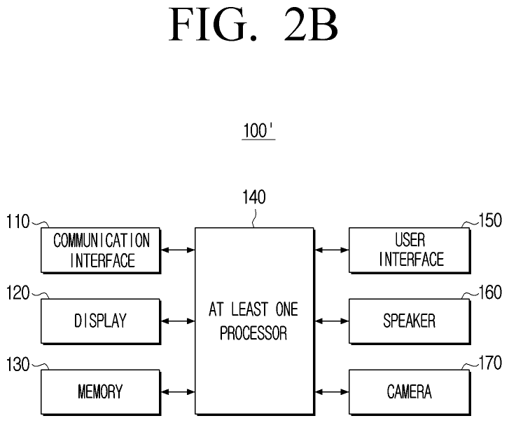

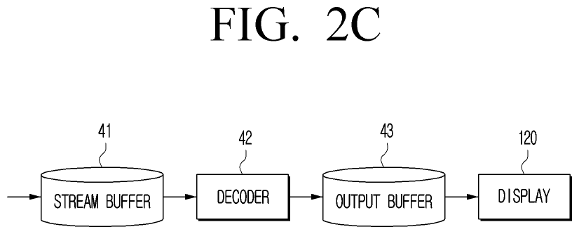

FIG. 2A is a block diagram illustrating a configuration of a display device according to an embodiment.

According to FIG. 2A, a display device 100 includes a communication interface 110, a display 120, memory 130, and at least one processor 140.

The communication interface 110 may support various communication methods depending on implementation examples of the display device 100. For example, the communication interface 110 may perform communication with an external device, an external storage medium (e.g., a USB memory), an external server (e.g., a cloud server), etc. through communication methods such as Bluetooth, AP-based Wi-Fi (Wi-Fi, a wireless LAN network), Zigbee, a wired/wireless local area network (LAN), a wide area network (WAN), an Ethernet, the IEEE 1394, a high-definition multimedia interface (HDMI), a universal serial bus (USB), a mobile high-definition link (MHL), the Audio Engineering Society/European Broadcasting Union (AES/EBU), Optical, Coaxial, etc.

The display 120 may be implemented as a display including self-luminous elements, or a display including non-self-luminous elements and a backlight. For example, the display 120 may be implemented as displays in various forms such as a liquid crystal display (LCD), an organic light emitting diodes (OLED) display, light emitting diodes (LED), micro LED, mini LED, a plasma display panel (PDP), a quantum dot (QD) display, quantum dot light emitting diodes (QLED), etc. Inside the display 120, driving circuits that may be implemented in forms such as an a-si TFT, a low temperature poly silicon (LTPS) TFT, an organic TFT (OTFT), etc., and a backlight unit, etc. may also be included together. According to an embodiment, on the front surface of the display 120, a touch sensor that has a form such as a touch film, a touch sheet, a touch pad, etc. and detects a touch operation may be arranged and implemented to detect various types of touch inputs. For example, the display 120 may detect various types of touch inputs such as a touch input by a user's hand, a touch input by an input device such as a stylus pen, a touch input by a specific electrostatic material, etc. Here, the input device may be implemented as an input device in a pen type that can be referred to as various terms such as an electronic pen, a stylus pen, an S-pen, etc. According to an embodiment, the display 120 may be implemented as a flat display, a curved display, a flexible display that can be folded and/or rolled, etc.

The memory 130 may store data necessary for various embodiments. The memory 130 may be implemented in a form of memory embedded in the display device 100, or implemented in a form of memory that can be attached to or detached from the display device 100 according to the usage of stored data. For example, in the case of data for operating the display device 100, the data may be stored in memory embedded in the display device 100, and in the case of data for an extended function of the display device 100, the data may be stored in memory that can be attached to or detached from the display device 100. Meanwhile, in the case of memory embedded in the display device 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the display device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that can be connected to a USB port (e.g., a USB memory), etc.

The at least one processor 140 controls the overall operations of the display device 100. Specifically, the at least one processor 140 may be connected with each component of the display device 100, and control the overall operations of the display device 100. For example, the at least one processor 140 may be electrically connected with the display 120 and the memory 130, and control the overall operations of the display device 100. The at least one processor 140 may consist of one or a plurality of processors.

The at least one processor 140 may perform the operations of the display device 100 according to various embodiments by executing the at least one instruction stored in the memory 130.

The at least one processor 140 may include one or more of a central processing unit (CPU), a graphics-processing unit (GPU), an accelerated processing unit (APU), a many integrated core (MIC), a digital signal processor (DSP), a neural processing unit (NPU), a hardware accelerator, or a machine learning accelerator. The at least one processor 140 may control one or a random combination of the other components of the display device, and perform an operation related to communication or data processing. Also, the at least one processor 140 may execute one or more programs or instructions stored in the memory. For example, the at least one processor 140 may perform the method according to an embodiment of the disclosure by executing the at least one instruction stored in the memory.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 140 may be implemented as a single core processor including one core, or may be implemented as one or more multicore processors including a plurality of cores (e.g., multicores of the same kind or multicores of different kinds). In case the at least one processor 140 is implemented as multicore processors, each of the plurality of cores included in the multicore processors may include internal memory of the processor such as cache memory, on-chip memory, etc., and common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto. Hereinafter, the at least one processor 140 will be referred to as the processor 140, for the convenience of explanation.

FIG. 2B is a block diagram illustrating in detail a configuration of a display device according to an embodiment.

According to FIG. 2B, the display device 100′ may include a communication interface 110, a display 120, memory 130, at least one processor 140, a user interface 150, a speaker 160, and a sensor 170. Among the components illustrated in FIG. 2B, regarding components overlapping with the components illustrated in FIG. 2A, detailed explanation will be omitted.

The user interface 150 may be implemented as a device such as a button, a touch pad, a mouse, and a keyboard, or may be implemented as a touch screen that can perform the aforementioned display function and a manipulation input function together, etc.

The speaker 160 may be a component that outputs not only various kinds of audio data but also various kinds of notification sounds or voice messages, etc. The processor 140 may control the speaker 160 to output information or various kinds of notifications corresponding to UI screens according to various embodiments of the disclosure in audio forms.

The camera 170 may be turned on according to a predetermined event and perform photographing. The camera 170 may convert a photographed image into an electric signal, and generate image data based on the converted signal. For example, a subject may be converted into an electric image signal through a semiconductor optical element (a charge coupled device (CCD)), and the image signal converted as such may be amplified and converted into a digital signal, and then go through signal processing.

Other than the above, the display device 100′ may include a microphone (not shown), a sensor (not shown), a tuner (not shown), and a demodulator (not shown) depending on implementation examples.

The microphone (not shown) is a component for receiving input of a user voice or other sounds, and converting them into audio data. Meanwhile, according to anther embodiment, the display device 100′ may receive a user voice input through an external device through the communication interface 110.

The sensor (not shown) may include various types of sensors such as a touch sensor, a proximity sensor, an acceleration sensor, a geomagnetic sensor, a gyro sensor, a pressure sensor, a position sensor, an illumination sensor, etc.

The tuner (not shown) may tune a channel selected by a user among radio frequency (RF) broadcast signals received through an antenna, or all pre-stored channels, and receive an RF broadcast signal.

The demodulator (not shown) may receive a converted digital IF (DIF) signal from the tuner and demodulate the signal, and perform channel demodulation, etc.

FIG. 2C is a diagram for illustrating a method of processing a content of a display device according to an embodiment.

According to the embodiment illustrated in FIG. 2C, a content that is streamed to the display device 100 in real time may be stored in a stream buffer (or a reception buffer) 41. Here, the streamed content may be a content encoded in an external server 20 (FIG. 1). Accordingly, the content stored in the stream buffer 41 may be provided to a decoder 42 and decoded, and the decoded content may be buffered in an output buffer 43, and output through the display 120. Here, the decoder 42 may be implemented in a form of a kind of DSP.

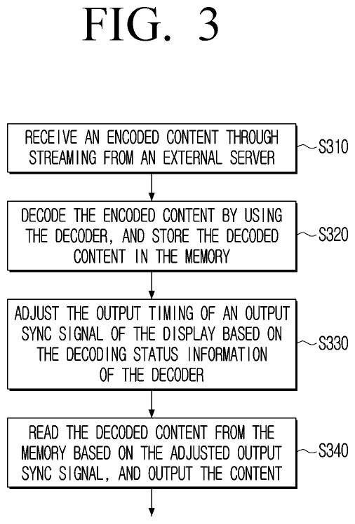

FIG. 3 is a diagram for illustrating a control method of a display device according to an embodiment.

According to the embodiment illustrated in FIG. 3, when an encoded content is received through streaming from an external server in the step S310, the processor 140 may decode the encoded content by using the decoder, and store the decoded content in the memory 130 in the step S320.

The processor 140 may adjust the output timing of an output sync signal of the display 120 based on the decoding status information of the decoder in the step S330.

Afterwards, the processor 140 may read the decoded content from the memory 130 based on the adjusted output sync signal, and output the content through the display 120 in the step S340.

According to an embodiment, the decoder may decode frames included in an encoded content in units of decoding blocks. However, the disclosure is not limited thereto, and the decoder may decode frames included in an encoded content in units of decoding lines. Hereinafter, explanation will be described by assuming that the decoder decodes frames in units of decoding blocks.

When decoding status information including the position information of the decoding block (or the decoding line) corresponding to the first frame that is currently decoded is received from the decoder, the processor 140 may delay an output sync signal of the display 120 based on the position information of the current decoding block. Accordingly, the first frame for which decoding was completed may be read from the memory 130 and output by synchronizing the frame to the delayed output sync signal. That is, the processor 140 may change the timing of reading a decoded frame from the memory 130 (i.e., the output timing of an output sync signal) based on the position information of the current decoding block.

The processor 140 may perform image processing including at least one of image enhancement, image restoration, image transformation, image analysis, or image understanding for a decoded frame depending on needs, and output the frame.

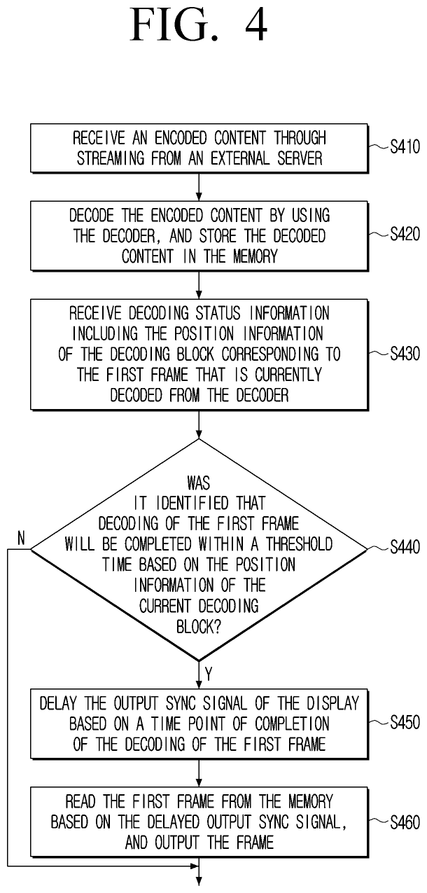

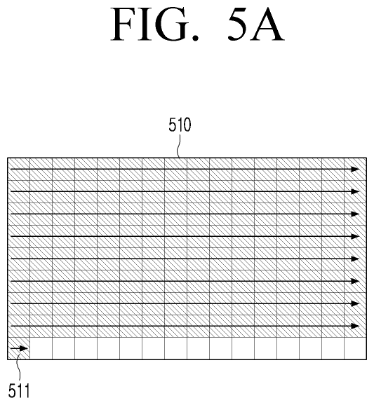

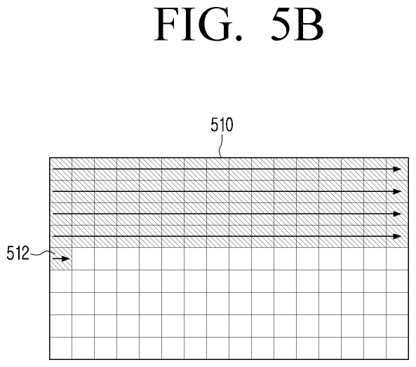

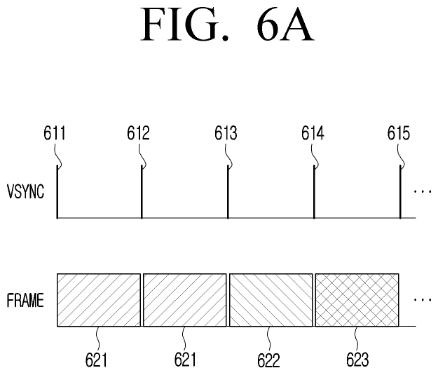

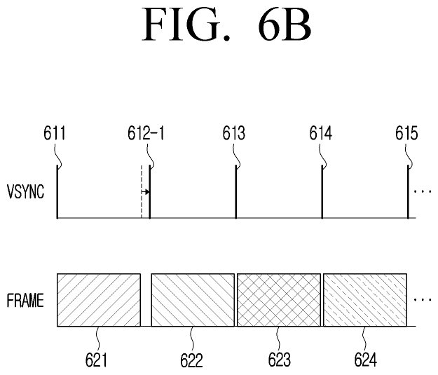

FIG. 4, FIG. 5A, FIG. 5B, FIG. 6A, and FIG. 6B are diagrams for illustrating a control method of a display device according to an embodiment.

According to the embodiment illustrated in FIG. 4, when an encoded content is received through streaming from an external server in the step S410, the processor 140 may decode the encoded content by using the decoder, and store the decoded content in the memory 130 in the step S420.

Then, the processor 140 may receive decoding status information including the position information of the decoding block corresponding to the first frame that is currently decoded from the decoder in the step S430.

Then, the processor 140 may identify whether decoding of the first frame will be completed within a threshold time based on the position information of the current decoding block in the step S440.

Then, if it is identified that decoding of the first frame will be completed within the threshold time in the step S440: Y, the processor 140 may delay the output sync signal of the display 120 based on a time point of completion of the decoding of the first frame in the step S450.

Then, the processor 140 may read the first frame from the memory 130 based on the delayed output sync signal, and output the frame.

According to an embodiment, the processor 140 may read a second frame that was decoded before the first frame from the memory 130 and output the frame by synchronizing the frame to the output timing of a first Vsync signal. Then, if it is identified that decoding of the first frame will be completed within the threshold time based on the position information of the current decoding block, the processor 140 may delay the output timing of a second Vsync signal after the first Vsync signal until the time point of completion of decoding and output the signal. Then, the processor 140 may read the first frame that was decoded from the memory 130 and output the frame by synchronizing the frame to the output timing of the first Vsync signal.

For example, a decoding status as illustrated in FIG. 5A and FIG. 5B will be assumed. As illustrated in FIG. 5A, in case decoding was completed to the first block 511 of the last line, the processor 140 may identify that decoding will be completed within the threshold time. Also, as illustrated in FIG. 5B, in case decoding was completed to the first block 512 of the middle line, the processor 140 may identify that decoding will not be completed within the threshold time. For example, the processor 140 may identify the time for decoding the remaining blocks based on the position information of the current decoding block received from the decoder, and identify whether the time belongs within the threshold time. Here, the threshold time may be a predefined value. For example, the threshold time may be set based on the characteristics of the display 120. For example, the threshold time may be set based on the time that takes for discharge of the display 120. That is, if it is identified that decoding will be completed before the display 120 is discharged, the first frame may be output quickly without repeatedly outputting the second frame by delaying the output timing of a sync signal, but in a contrary case, if the output timing of a sync signal is delayed, by delay due to charging, etc. as the display 120 is discharged, the effect of not repeatedly outputting the second frame will be reduced.

For example, as illustrated in FIG. 6A, if it is identified that the first frame 622 will not be decoded within the threshold time based on the decoding status of the first frame 622 after the second frame 621 after the second frame 621 was output based on the first Vsync signal 611, the processor 140 may repeatedly read and output the second frame 621 based on the second Vsync signal 612. Accordingly, the first frame 622 may be output based on the third Vsync signal 613 after the second frame 621 was repeatedly output.

In contrast, as illustrated in FIG. 6B, if it is identified that the first frame 622 will be decoded within the threshold time based on the decoding status of the first frame 622 after the second frame 621 was output based on the first Vsync signal 611, the processor 140 may delay the second Vsync signal 612 until completion of the decoding of the first frame 622, and then read and output the first frame 622 based on the delayed second Vsync signal 612-1. Accordingly, output delay as the second frame 621 is repeatedly output can be reduced. That is, compared to a case wherein the second frame 621 is repeatedly output as the decoding of the first frame 622 was not completed, the frame can be output by one frame faster, and thus the output latency can be reduced.

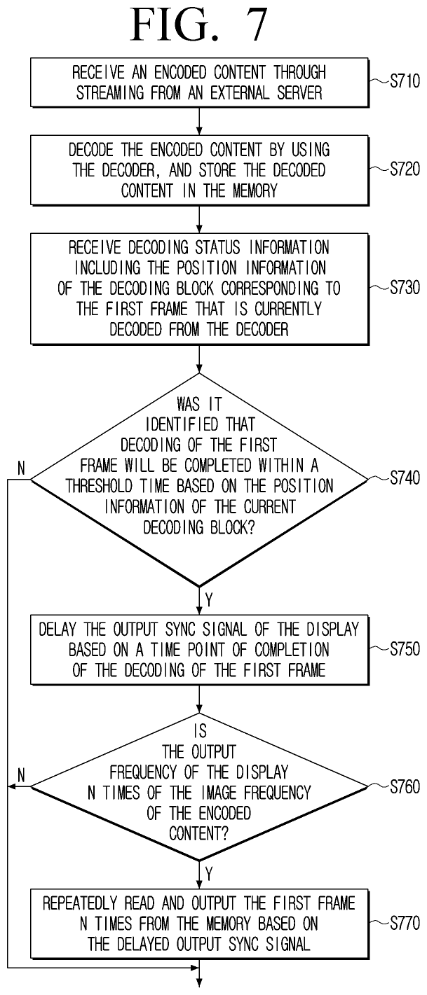

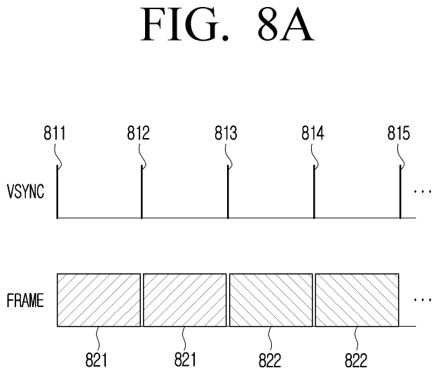

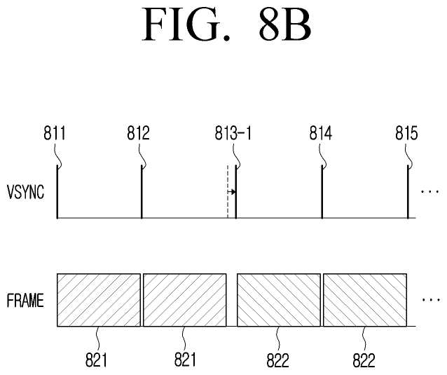

FIG. 7, FIG. 8A, and FIG. 8B are diagrams for illustrating a control method of a display device according to an embodiment.

According to the embodiment illustrated in FIG. 7, when an encoded content is received through streaming from an external server in the step S710, the processor 140 may decode the encoded content by using the decoder, and store the decoded content in the memory 130 in the step S720.

Then, the processor 140 may receive decoding status information including the position information of the decoding block corresponding to the first frame that is currently decoded from the decoder in the step S730.

Then, the processor 140 may identify whether decoding of the first frame will be completed within a threshold time based on the position information of the current decoding block in the step S740.

Then, if it is identified that decoding of the first frame will be completed within the threshold time in the step S740: Y, the processor 140 may delay the output sync signal of the display 120 based on a time point of completion of the decoding of the first frame in the step S750.

In this case, the processor 140 may identify whether an output frequency of the display 120 is n times of an image frequency of the encoded content in the step S750. Here, n may be a number bigger than or equal to 2 (e.g., an integer).

If it is identified that the output frequency of the display 120 is n times of the image frequency of the encoded content in the step S750: Y, the processor 140 may repeatedly read the first frame from the memory 130 n times and output the frame based on the delayed output sync signal in the step S760. For example, the processor 140 may repeatedly output the second frame that was decoded before the first frame n times, and then delay the output sync signal based on the position information of the current decoding block and repeatedly read the decoded first frame n times and output the frame by synchronizing the frame to the delayed output sync signal.

For example, as illustrated in FIG. 8A, in case the output frequency of the display 120 is two times of the image frequency of an encoded content, the processor 140 may repeatedly output the second frame 821 based on the first Vsync signal 811 and the second Vsync signal 812, and repeatedly output the first frame 822 based on the third Vsync signal 813 and the fourth Vsync signal 814 afterwards.

Meanwhile, if it is identified that decoding of the first frame 822 is not completed at the output timing of the third Vsync signal 813 and the first frame 822 will not be decoded within the threshold time based on the decoding status, the processor 140 may additionally output the second frame 821 repeatedly (not shown) based on the third Vsync signal 813.

However, if it is identified that the first frame 822 will be decoded within the threshold time based on the decoding status of the first frame 822, as illustrated in FIG. 8B, the processor 140 may delay the third Vsync signal 813, and repeatedly read and repeatedly output the decoded first frame 822 based on the delayed third Vsync signal 813-1 and the fourth Vsync signal 814. Here, it is obvious that the later Vsync signals including the fourth Vsync signal 814 will automatically be output while being delayed according to delay of the third Vsync signal 813-1. For example, in case the output frequency is 60 Hz, due to delay of the third Vsync signal 813-1, the interval between the second Vsync signal 812 and the delayed third Vsync signal 813-1 is longer than 16.6 ms ( 1/60 s), but the interval between the delayed third Vsync signal 813-1 and the fourth Vsync signal 814 will maintain 16.6 ms ( 1/60 s) based on 60 Hz.

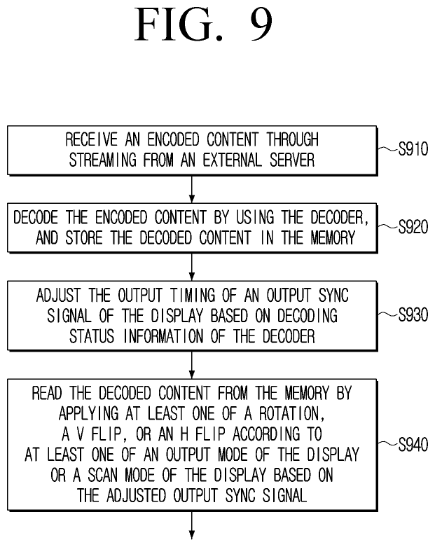

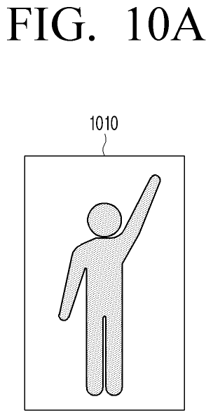

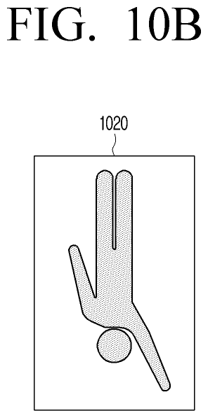

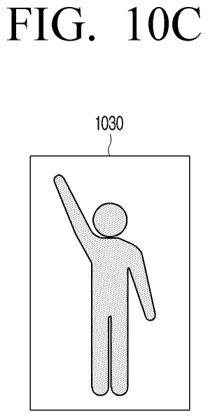

FIG. 9, FIG. 10A, FIG. 10B, and FIG. 10C are diagrams for illustrating a control method of a display device according to an embodiment.

According to the embodiment illustrated in FIG. 9, when an encoded content is received through streaming from an external server in the step S910, the processor 140 may decode the encoded content by using the decoder, and store the decoded content in the memory 130 in the step S920.

The processor 140 may adjust the output timing of an output sync signal of the display 120 based on decoding status information of the decoder in the step S930.

Afterwards, the processor 140 may read the decoded content from the memory 130 by applying at least one of a rotation, a vertical (V) flip, or a horizontal (H) flip based on at least one of an output mode of the display 120 or a scan mode of the display 120 based on the adjusted output sync signal, and output the content through the display 120 in the step S340. Here, the output mode may include at least one of a horizontal output mode or a vertical output mode. Also, the scan mode may include not only scan modes in up>down and left>right directions, but also at least one of a mode of scanning from a lower direction to an upper direction or a mode of scanning from a left direction to a right direction.

According to an embodiment, if it is identified that the output mode of the display 120 is a vertical mode, the processor 140 may read a decoded image from the memory 130 by applying a rotation to the image. That is, in order that pixel values read based on the output mode in a vertical direction can be output immediately, the pixel values may be read in the order of pixel values corresponding to the image in the rotated direction, and may be immediately output, i.e., scanned on the display 120.

FIG. 10A to FIG. 10C are diagrams for illustrating a method of reading a decoded content according to a scan mode.

For example, in case an input image is like the image 1010 illustrated in FIG. 10A, the processor 140 may read the decoded image in the order of pixels as in FIG. 10B or FIG. 10C according to the scan mode of the display 120, and output the image.

According to an embodiment, in case the scan mode of the display 120 is a mode of scanning from the lower direction to the upper direction, the processor 140 may read a decoded image in the order of pixels 1020 as in FIG. 10B, and output the image. For example, when reading a decoded image, the processor 140 may read the line address from the bottom line by applying a V flip.

According to another embodiment, in case the scan mode of the display 120 is a mode of scanning from the left direction to the right direction, the processor 140 may read a decoded image in the order of pixels 1030 as in FIG. 10C, and output the image. For example, when reading a decoded image, the processor 140 may read the line address from the left line by applying an H flip.

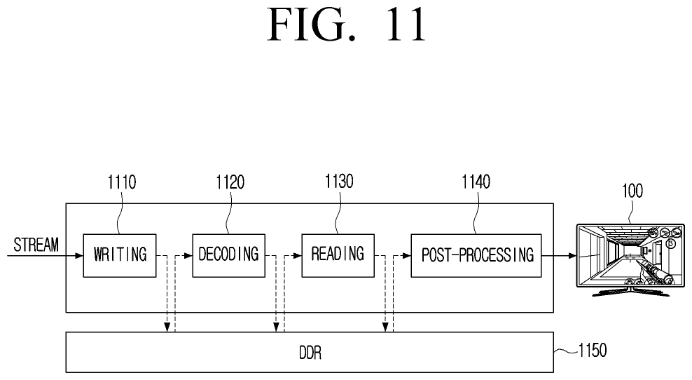

FIG. 11 is a diagram for illustrating an implementation example of a method of providing a content according to an embodiment.

As illustrated in FIG. 11, if a stream is received from an external server, the display device 100 may process and output the received stream. According to an embodiment, the external server may provide a cloud gaming service, and the received stream may be a game content stream. In this case, if a user control instruction for an output game screen is received, the display device 100 may transmit the user control instruction to the external server. Then, when an encoded content to which the user control instruction is reflected is streamed from the external server, the display device 100 may decode the encoded content and store it in the memory 1150, and read the decoded content from the memory 1150 and output the content. For example, the memory 1150 may be double data rate (DDR) memory, but is not limited thereto. According to an embodiment, the external server may transmit images of various resolutions and various compressed images to the display device 100. For example, the external server may transmit at least one image among an image of standard definition (SD), an image of high definition (HD), an image of FHD, an image of UHD, and an image of a resolution higher than UHD to the display device 100. Also, the external server may transmit a stream in a form compressed as moving picture experts group (MPEG) (e.g., MP2, MP4, MP7, etc.), joint photographic coding experts group (JPEG), advanced video coding (AVC), H.264, H.265, high efficiency video codec (HEVC), VC-1, VP8, VP9, and AOMedia Video 1 (AV1), etc. to the display device 100.

According to FIG. 11, if a stream, i.e., an encoded content is received from an external server, the display device 100 may write 1110 the received content in the memory 1150, and decode 1120 the content written in the memory 150, and store the content in the memory 1150. Then, the display device 100 may read 1130 the decoded content and store the content in the memory 1150. Afterwards, the display device 100 may perform post-processing of the content stored in the memory 1150, and output the content. Meanwhile, in case post-processing is not necessary, the display device 100 may read the decoded content and output the content immediately. For example, post-processing may include processing such as scaling.

According to an embodiment, the display device 100 may delay an output sync signal based on decoding status information of a frame, and output the decoded frame by synchronizing the frame to the delayed output sync signal. For example, as described above, the display device 100 may delay an output sync signal based on the decoding status of the first frame, and read and output the first frame for which decoding was completed by synchronizing the frame to the delayed output sync signal. In case the decoding of the first frame was not completed, the frame can be output by one frame faster compared to a case of repeatedly outputting the previous frame, and thus the output latency can be reduced.

According to an embodiment, when reading 1130 a decoded content, the display device 100 may read the content based on the output frequency. For example, in case the output frequency is n times of the image frequency, the display device 100 may repeatedly read and repeatedly output the decoded frame n times. That is, by maintaining the output scan rate of the display 120 and the decoding scan rate of the decoder to be identical, the output latency can be reduced.

Also, as described above, when reading 1130 a decoded content, the display device 100 may read the content by applying at least one of a rotation, a vertical (V) flip, or a horizontal (H) flip according to an output mode, a scan mode, etc. of the display device 100.

Meanwhile, according to an embodiment, if the resolution of an encoded content streamed from the external server varies according to the network status, the display device 100 may omit an image quality processing operation that is additionally applied to a relatively low resolution, such that the output latency is maintained. For example, the display device 100 may additionally perform image improvement processing such as improvement of sharpness, texture processing, etc. for an image of a low resolution, and if additional image processing is performed, the output latency is changed according to change of the resolution of the image. Accordingly, in order that the output latency can be maintained when necessary, the display device 100 may omit image improvement processing that is additionally performed for an image of a low resolution.

According to an embodiment, if a bitrate of an encoded content streamed from the external server is reduced according to the network status, the display device 100 may omit an artificial intelligence (AI) image quality processing operation that is additionally applied to a relatively low bitrate such that the output latency is maintained. For example, the display device 100 may additionally perform AI image quality processing such as AI upscaling for an image of a low bitrate, and if additional image processing is performed, the output latency is changed according to change of the bitrate of the image. Accordingly, in order that the output latency can be maintained when necessary, the display device 100 may omit AI image quality processing that is additionally performed for an image of a low bitrate.

In addition to the aforementioned embodiments, the display device 100 may perform operations similar to the aforementioned embodiments such that the output latency that is changed due to additional processing according to a game genre, etc., and the output latency that is changed due to additional processing according to motion blur improvement, etc. are maintained.

According to the aforementioned embodiments, the output latency can be minimized while maintaining the content quality in a low-latency streaming service such as a cloud gaming service. Accordingly, in the case of a game content, the game response speed is improved, and thus the user's convenience can be improved.

Meanwhile, the methods according to the aforementioned various embodiments of the disclosure may be implemented in forms of applications that can be installed on conventional display devices. Alternatively, the methods according to the aforementioned various embodiments of the disclosure may be performed by using an artificial neural network based on deep learning (or a deep artificial neural network), i.e., a learning network model. According to an embodiment, at least one of downscaling, decoding, encoding, or upscaling may be performed through a trained neural network model.

Also, the methods according to the aforementioned various embodiments of the disclosure may be implemented just with software upgrade, or hardware upgrade of conventional display devices.

In addition, the aforementioned various embodiments of the disclosure may be performed through an embedded server provided on a display device, or an external server of a display device.

Meanwhile, according to an embodiment of the disclosure, the aforementioned various embodiments may be implemented as software including instructions stored in machine-readable storage media, which can be read by machines (e.g.: computers). The machines refer to devices that call instructions stored in a storage medium, and can operate according to the called instructions, and the devices may include a display device according to the aforementioned embodiments (e.g.: a display device A). In case an instruction is executed by a processor, the processor may perform a function corresponding to the instruction by itself, or by using other components under its control. An instruction may include a code that is generated or executed by a compiler or an interpreter. A storage medium readable by machines may be provided in the form of a non-transitory storage medium. Here, the term ‘non-transitory’ only means that the storage medium does not include signals and is tangible, and the term does not distinguish a case wherein data is stored in the storage medium semi-permanently and a case wherein data is stored temporarily.

Also, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

In addition, each of the components according to the aforementioned various embodiments (e.g.: a module or a program) may consist of a singular object or a plurality of objects, and among the aforementioned corresponding sub components, some sub components may be omitted, or other sub components may be further included in the various embodiments. Alternatively or additionally, some components (e.g.: a module or a program) may be integrated as an object, and perform functions performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

1. A display device comprising:
a communication interface;
a display;
memory; and
at least one processor configured to:
based on an encoded content being streamed from an external server through the communication interface, decode the encoded content by using a decoder, and store the decoded content in the memory,
adjust an output timing of an output sync signal of the display based on decoding status information of the decoder, and
read the decoded content from the memory based on the adjusted output sync signal and output the content through the display.

2. The display device of claim 1, wherein
the decoder decodes frames included in the encoded content in units of decoding blocks, and
the at least one processor is configured to:
based on receiving the decoding status information including position information of a decoding block corresponding to a first frame that is currently decoded from the decoder, delay the output sync signal of the display on the basis of the position information of the current decoding block, and read the first frame for which decoding was completed from the memory and output the first frame by synchronizing the first frame to the delayed output sync signal.

3. The display device of claim 2, wherein the at least one processor is configured to:
based on identifying that decoding of the first frame will be completed within a threshold time on the basis of the position information of the current decoding block, delay the output sync signal of the display based on a time point of completion of the decoding of the first frame, and read the first frame for which decoding was completed from the memory and output the first frame by synchronizing the first frame to the delayed output sync signal.

4. The display device of claim 3, wherein the at least one processor is configured to:
read a second frame that was decoded before the first frame from the memory and output the second frame by synchronizing the second frame to the output timing of a first Vsync signal, and based on identifying that decoding of the first frame will be completed within a threshold time on the basis of position information of the current decoding block, delay the output timing of a second Vsync signal after the first Vsync signal until the time point of completion of decoding and output the signal, and read the decoded first frame from the memory and output the first frame by synchronizing the first frame to the output timing of the first Vsync signal.

5. The display device of claim 2, wherein the at least one processor is configured to:
based on an output frequency of the display being n times of an image frequency of the encoded content, output a second frame that was decoded before the first frame repeatedly by n times, and then delay the output sync signal of the display based on the position information of the current decoding block, and read the first frame for which decoding was completed from the memory and output the first frame by synchronizing the first frame to the delayed output sync signal.

6. The display device of claim 5, wherein the at least one processor is configured to:
based on the output frequency of the display being n times of the image frequency of the encoded content, read the decoded first frame from the memory repeatedly by n times and output the first frame by synchronizing the first frame to the delayed output sync signal.

7. The display device of claim 1, wherein the at least one processor is configured to:
read the decoded content from the memory by applying at least one of a rotation, a vertical (V) flip, or a horizontal (H) flip based on at least one of an output mode of the display or a scan mode of the display, and output the content through the display, and
the output mode includes a horizontal output mode or a vertical output mode.

8. The display device of claim 1, wherein the at least one processor is configured to:
based on a resolution of the encoded content streamed from the external server varying according to a network status, omit an image quality processing operation that is additionally applied to a relatively low resolution such that output latency is maintained.

9. The display device of claim 1, wherein the at least one processor is configured to:
based on a bitrate of the encoded content streamed from the external server being reduced according to a network status, omit an artificial intelligence (AI) image quality processing operation that is additionally applied to a relatively low bitrate such that output latency is maintained.

10. The display device of claim 1, wherein
the external server provides a cloud gaming service, and
the at least one processor is configured to:
based on receiving a user control instruction for a game screen output through the display, transmit the user control instruction to the external server through the communication interface,
based on an encoded content to which the user control instruction was reflected being streamed from the external server, decode the encoded content and store the content in the memory, and
read the decoded content from the memory and output the content through the display.

11. A control method of a display device, the control method comprising:
based on an encoded content being streamed from an external server, decoding the encoded content by using a decoder, and storing the decoded content in memory;
adjusting an output timing of an output sync signal of a display based on decoding status information of the decoder; and
reading the decoded content based on the adjusted output timing and outputting the content through the display.

12. The control method of claim 11,
wherein the decoder decodes frames included in the encoded content in units of decoding blocks, and
the adjusting the output timing of the output sync signal includes:
based on receiving the decoding status information including position information of a decoding block corresponding to a first frame that is currently decoded from the decoder, delaying the output sync signal of the display on the basis of the position information of the current decoding block, and
the outputting through the display includes:
reading the first frame for which decoding was completed from the memory and outputting the first frame by synchronizing the first frame to the delayed output sync signal.

13. The control method of claim 12, wherein the adjusting the output timing of the output sync signal includes:
based on identifying that decoding of the first frame will be completed within a threshold time on the basis of the position information of the current decoding block, delaying the output sync signal of the display based on a time point of completion of the decoding of the first frame.

14. The control method of claim 13, further comprising:
reading a second frame that was decoded before the first frame from the memory and outputting the second frame by synchronizing the second frame to the output timing of a first Vsync signal, and
the adjusting the output timing of the output sync signal includes:
based on identifying that decoding of the first frame will be completed within a threshold time on the basis of the position information of the current decoding block, delaying the output timing of a second Vsync signal after the first Vsync signal until the time point of completion of decoding and outputting the signal, and
the outputting through the display includes:
reading the decoded first frame from the memory and outputting the first frame by synchronizing the first frame to the output timing of the first Vsync signal.

15. A non-transitory computer-readable medium storing computer instructions which, when executed by a processor of a display device, cause the display device perform operations, wherein the operations incudes:
based on an encoded content being streamed from an external server, decoding the encoded content by using a decoder, and storing the decoded content in memory;
adjusting an output timing of an output sync signal of a display based on decoding status information of the decoder; and
reading the decoded content based on the adjusted output timing and outputting the content through the display.

16. The non-transitory computer-readable medium of claim 15,
wherein the decoder decodes frames included in the encoded content in units of decoding blocks, and
the adjusting the output timing of the output sync signal includes:
based on receiving the decoding status information including position information of a decoding block corresponding to a first frame that is currently decoded from the decoder, delaying the output sync signal of the display on the basis of the position information of the current decoding block, and
the outputting through the display includes:
reading the first frame for which decoding was completed from the memory and outputting the first frame by synchronizing the first frame to the delayed output sync signal.

17. The non-transitory computer-readable medium of claim 16, wherein the adjusting the output timing of the output sync signal includes:
based on identifying that decoding of the first frame will be completed within a threshold time on the basis of the position information of the current decoding block, delaying the output sync signal of the display based on a time point of completion of the decoding of the first frame.

18. The non-transitory computer-readable medium of claim 17, further comprising:
reading a second frame that was decoded before the first frame from the memory and outputting the second frame by synchronizing the second frame to the output timing of a first Vsync signal, and
the adjusting the output timing of the output sync signal includes:
based on identifying that decoding of the first frame will be completed within a threshold time on the basis of the position information of the current decoding block, delaying the output timing of a second Vsync signal after the first Vsync signal until the time point of completion of decoding and outputting the signal, and
the outputting through the display includes:
reading the decoded first frame from the memory and outputting the first frame by synchronizing the first frame to the output timing of the first Vsync signal.

19. The non-transitory computer-readable medium of claim 16, wherein the operations further comprise:
based on an output frequency of the display being n times of an image frequency of the encoded content, outputting a second frame that was decoded before the first frame repeatedly by n times, and then delay the output sync signal of the display based on the position information of the current decoding block, and
reading the first frame for which decoding was completed from the memory and outputting the first frame by synchronizing the first frame to the delayed output sync signal.

20. The non-transitory computer-readable medium of claim 19, wherein the reading the first frame includes:
based on the output frequency of the display being n times of the image frequency of the encoded content, read the decoded first frame from the memory repeatedly by n times and output the first frame by synchronizing the first frame to the delayed output sync signal.
